(19) United States
(12) Patent Application Publication
(10) Pub. No.: US 2024/0334425 A1
(43) Pub. Date: Oct. 3, 2024

(54) TECHNIQUES FOR RANDOM ACCESS CHANNEL RESOURCE SELECTION FOR SUB-BAND FULL DUPLEX

(71) Applicant: QUALCOMM Incorporated, San Diego, CA (US)

(72) Inventors: Muhammad Sayed Khairy ABDELGHAFFAR, San Jose, CA (US); Gokul SRIDHARAN, Sunnyvale, CA (US); Peter GAAL, San Diego, CA (US)

(21) Appl. No.: 18/192,494

(22) Filed: Mar. 29, 2023

(51) Int. Cl. H04W 72/1268; H04L 5/00; H04L 5/14; H04W 74/08

(52) U.S. Cl. CPC H04W 72/1268; H04L 5/0012; H04L 5/14; H04W 74/0833

(57) ABSTRACT

Various aspects of the present disclosure generally relate to wireless communication. In some aspects, a user equipment (UE) may receive information scheduling a physical uplink shared channel (PUSCH) transmission at least partially in a sub-band full duplex (SBFD) resource in connection with a random access channel procedure. The UE may transmit the PUSCH transmission on time and frequency (time-frequency) resources that are associated with a sub-band configuration of the SBFD resource. Numerous other aspects are described.

### FIELD OF THE DISCLOSURE

Aspects of the present disclosure generally relate to wireless communication and to techniques and apparatuses for random access channel resource selection for sub-band full duplex.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving information scheduling a physical uplink shared channel (PUSCH) transmission at least partially in a sub-band full duplex (SBFD) resource in connection with a random access channel procedure. The method may include transmitting the PUSCH transmission on time and frequency (time-frequency) resources that are associated with a sub-band configuration of the SBFD resource.

Some aspects described herein relate to a method of wireless communication performed by a network node. The method may include transmitting information scheduling a PUSCH transmission at least partially in an SBFD resource in connection with a random access channel procedure of a UE. The method may include receiving the PUSCH transmission on time-frequency resources that are associated with a sub-band configuration of the SBFD resource.

Some aspects described herein relate to a UE for wireless communication. The UE may include a memory and one or more processors coupled to the memory. The one or more processors may be configured to receive information scheduling a PUSCH transmission at least partially in an SBFD resource in connection with a random access channel procedure. The one or more processors may be configured to transmit the PUSCH transmission on time-frequency resources that are associated with a sub-band configuration of the SBFD resource.

Some aspects described herein relate to a network node for wireless communication. The network node may include a memory and one or more processors coupled to the memory. The one or more processors may be configured to transmit information scheduling a PUSCH transmission at least partially in an SBFD resource in connection with a random access channel procedure of a UE. The one or more processors may be configured to receive the PUSCH transmission on time-frequency resources that are associated with a sub-band configuration of the SBFD resource.

Some aspects described herein relate to a non-transitory computer-readable medium that stores a set of instructions for wireless communication by a UE. The set of instructions, when executed by one or more processors of the UE, may cause the UE to receive information scheduling a PUSCH transmission at least partially in an SBFD resource in connection with a random access channel procedure. The set of instructions, when executed by one or more processors of the UE, may cause the UE to transmit the PUSCH transmission on time-frequency resources that are associated with a sub-band configuration of the SBFD resource.

Some aspects described herein relate to a non-transitory computer-readable medium that stores a set of instructions for wireless communication by a network node. The set of instructions, when executed by one or more processors of the network node, may cause the network node to transmit information scheduling a PUSCH transmission at least partially in an SBFD resource in connection with a random access channel procedure of a UE. The set of instructions, when executed by one or more processors of the network node, may cause the network node to receive the PUSCH transmission on time-frequency resources that are associated with a sub-band configuration of the SBFD resource.

Some aspects described herein relate to an apparatus for wireless communication. The apparatus may include means for receiving information scheduling a PUSCH transmission at least partially in an SBFD resource in connection with a random access channel procedure. The apparatus may include means for transmitting the PUSCH transmission on time-frequency resources that are associated with a sub-band configuration of the SBFD resource.

Some aspects described herein relate to an apparatus for wireless communication. The apparatus may include means for transmitting information scheduling a PUSCH transmission at least partially in an SBFD resource in connection with a random access channel procedure of a UE. The apparatus may include means for receiving the PUSCH transmission on time-frequency resources that are associated with a sub-band configuration of the SBFD resource.

Aspects generally include a method, apparatus, system, computer program product, non-transitory computer-readable medium, UE, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a two-step random access channel (RACH) procedure, in accordance with the present disclosure.

FIG. 5 is a diagram illustrating an example of a four-step RACH procedure, in accordance with the present disclosure.

FIG. 6 is a diagram illustrating an example of a slot format, in accordance with the present disclosure.

FIG. 7 is a diagram illustrating examples of sub-band full-duplex (SBFD) communication in a wireless network, in accordance with the present disclosure.

FIG. 8 is a diagram illustrating an example of PUSCH transmission based at least in part on an SBFD slot, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

A user equipment (UE) may use a random access channel (RACH) procedure for various purposes, such as initial access, handover, connection reestablishment, beam failure recovery, and other purposes. A RACH procedure involves the transmission of various messages between the UE and a network node. In some example, a RACH procedure may involve frequency hopping. “Frequency hopping” refers to performing a first transmission at a first frequency location (a first hop) and a second transmission at a second frequency location (a second hop). For example, the UE may transmit a first part (e.g., a first repetition) of a physical uplink shared channel (PUSCH) transmission at the first frequency location and a second part (e.g., a second repetition) of the PUSCH transmission at a second frequency location, thereby improving frequency diversity.

A UE may communicate using sub-band full duplex (SBFD). In SBFD, different parts (i.e., sub-bands) of a bandwidth part (BWP) are configured as uplink sub-bands or downlink sub-bands. For example, the BWP may include, at a given time resource (e.g., a symbol or slot), one or more uplink sub-bands and one or more downlink sub-bands.

SBFD resources may introduce complexity for initial access and RACH procedures. For example, some RACH procedures may be defined at the granularity of the BWP (e.g., on the assumption that an entire uplink BWP is configured for uplink transmission to facilitate the RACH procedure). If the RACH procedure is defined at the granularity of the BWP, then the UE may attempt to utilize time or frequency resources that are configured for downlink communication, thereby causing self-interference or failed RACH procedures. For example, frequency hopping may be defined within the granularity of a BWP, which may lead some frequency hops to occur in a downlink sub-band, thereby reducing the flexibility and effectiveness of frequency hopping. As another example, time-domain resource allocation (TDRA) parameters for transmission of the PUSCH transmission may not take into account a guard period for downlink-to-uplink transition or transmission in a slot including both SBFD resources and non-SBFD resources, which may limit the number of available slots for PUSCH repetition and which may lead to failure to effectively utilize SBFD resources for communication. In addition, for PUSCH repetitions, the available slot may be determined based on availability of time resources in UL or flexible slots, and may not consider the availability of time and frequency resources of the UL subband in SBFD symbols.

Some techniques described herein provide selection of time and frequency (time-frequency) resources for a PUSCH transmission based at least in part on a sub-band configuration of an SBFD resource. For example, a PUSCH transmission may be scheduled at least partially in an SBFD resource. The UE may transmit a PUSCH transmission on time-frequency resources that are associated with a sub-band configuration of an SBFD resource, thus reducing the occurrence of self-interference or failed RACH procedures, improving UL coverage and reducing the latency. In some aspects, techniques described herein provide frequency hopping, for a PUSCH transmission, using a frequency offset derived from an uplink sub-band size of the SBFD resource, which improves flexibility and effectiveness of frequency hopping. In some aspects, techniques described herein provide TDRA parameters that are based at least in part on the PUSCH transmission occurring on an SBFD resource, such as TDRA parameters incorporating a guard period or TDRA parameters for use in slots including both SBFD resources and non-SBFD resources, thereby increasing the number of available slots for PUSCH repetition and improving utilization of SBFD resources for communication.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

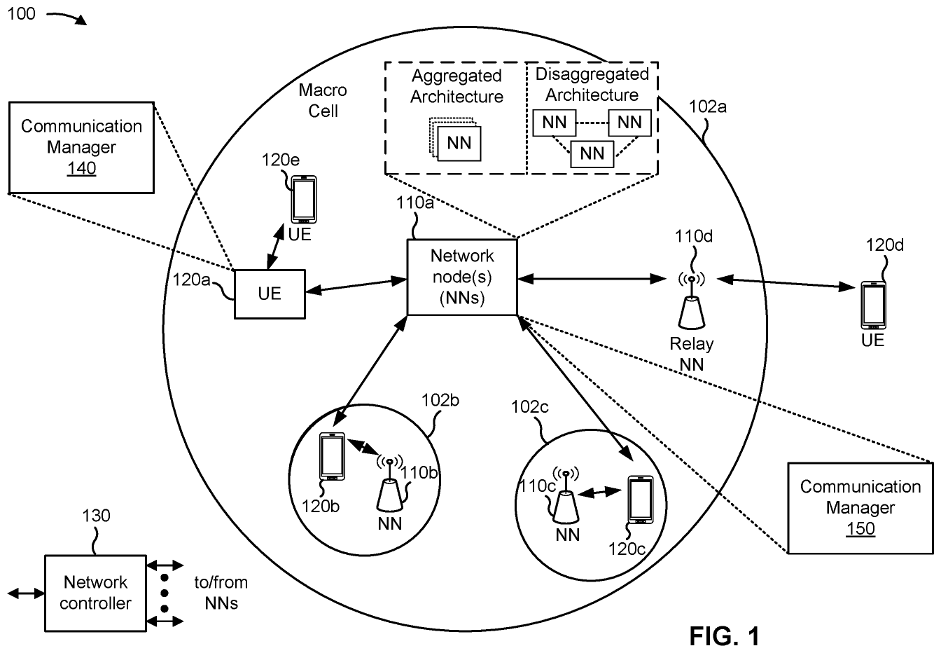

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive information scheduling a PUSCH transmission or PUSCH retransmission at least partially in an SBFD resource in connection with initial access and a random access channel procedure; and transmit the PUSCH transmission on time-frequency resources that are associated with a sub-band configuration of the SBFD resource. Additionally, or alternatively, the communication manager 140 may perform one or more other operations described herein.

In some aspects, the network node 110 may include a communication manager 150. As described in more detail elsewhere herein, the communication manager 150 may transmit information scheduling a PUSCH transmission at least partially in an SBFD resource in connection with initial access and/or a random access channel procedure of a UE; and receive the PUSCH transmission on time-frequency resources that are associated with a sub-band configuration of the SBFD resource. Additionally, or alternatively, the communication manager 150 may perform one or more other operations described herein.

As indicated above, FIG. 1 is provided as an example. Other examples may differ from what is described with regard to FIG. 1.

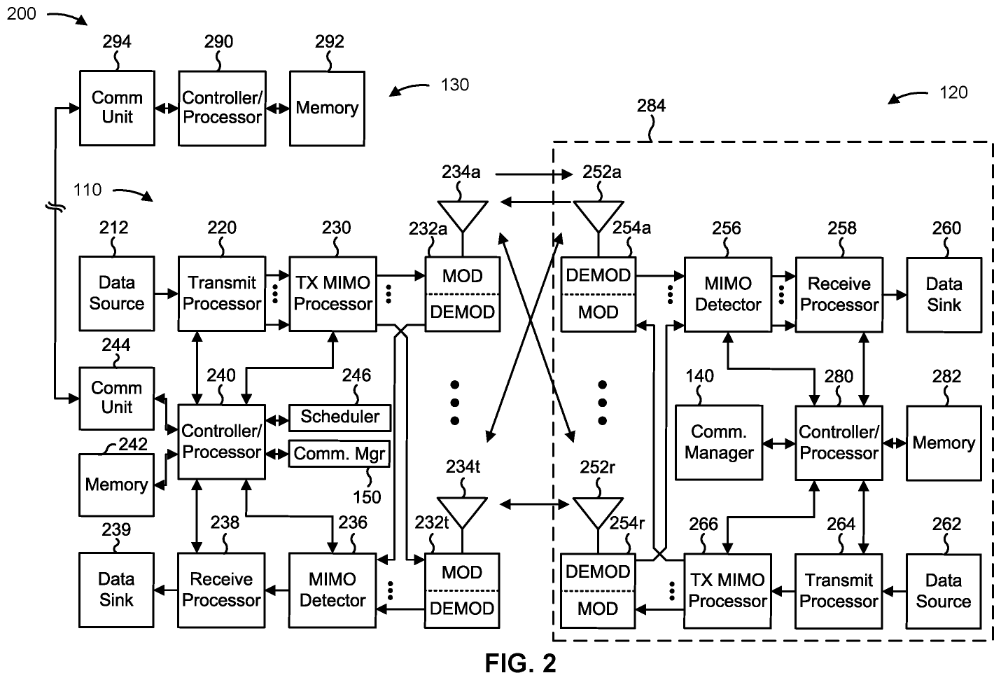

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

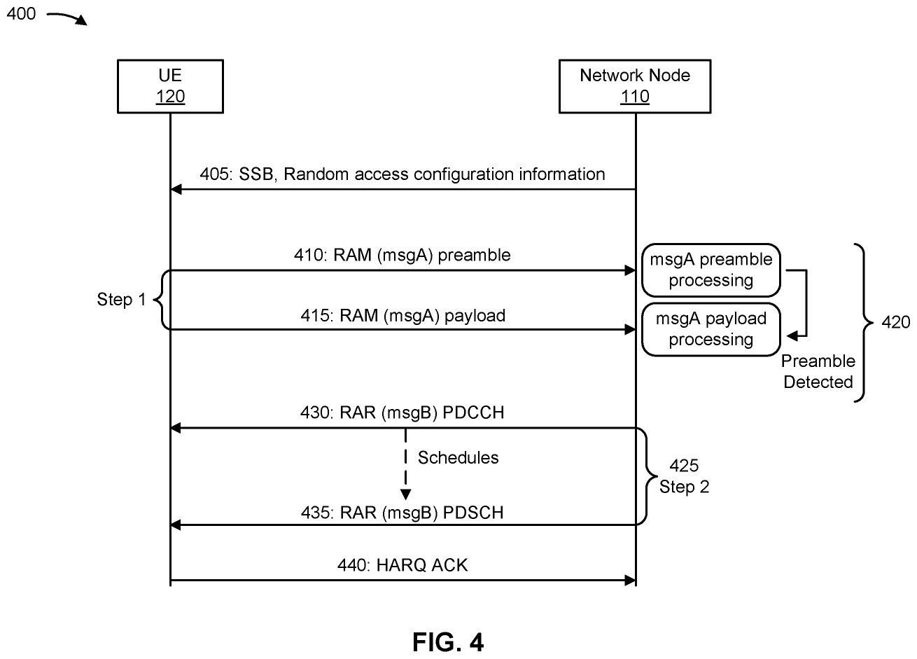

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-12).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

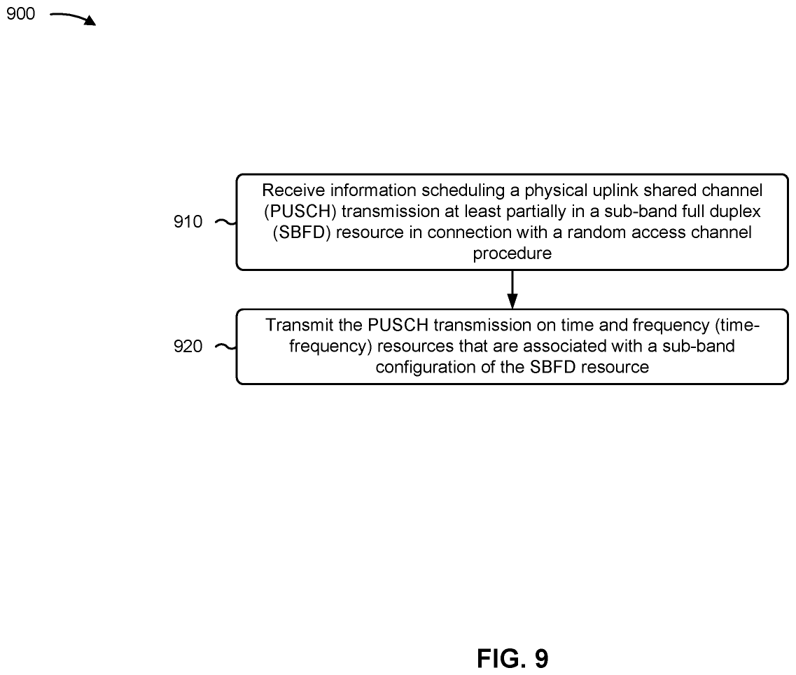

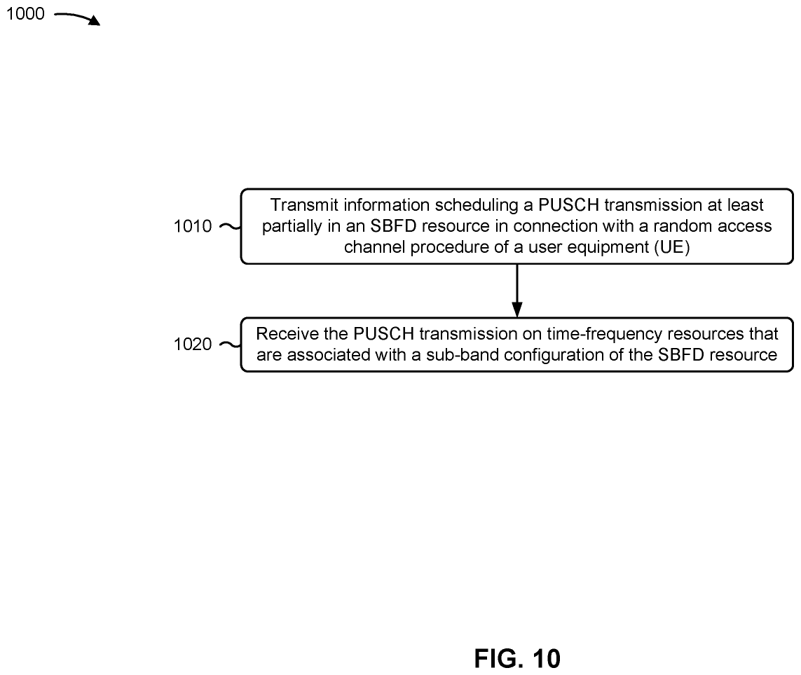

The controller/processor 240 of the network node 110, the controller/processor 280 of the UE 120, or any other component(s) of FIG. 2 may perform one or more techniques associated with frequency hopping for SBFD, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving information scheduling a PUSCH transmission at least partially in an SBFD resource in connection with a random access channel procedure; and/or means for transmitting the PUSCH transmission on time and frequency (time-frequency) resources that are associated with a sub-band configuration of the SBFD resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting information scheduling a PUSCH transmission at least partially in an SBFD resource in connection with a random access channel procedure of a UE; and/or means for receiving the PUSCH transmission on time-frequency resources that are associated with a sub-band configuration of the SBFD resource. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

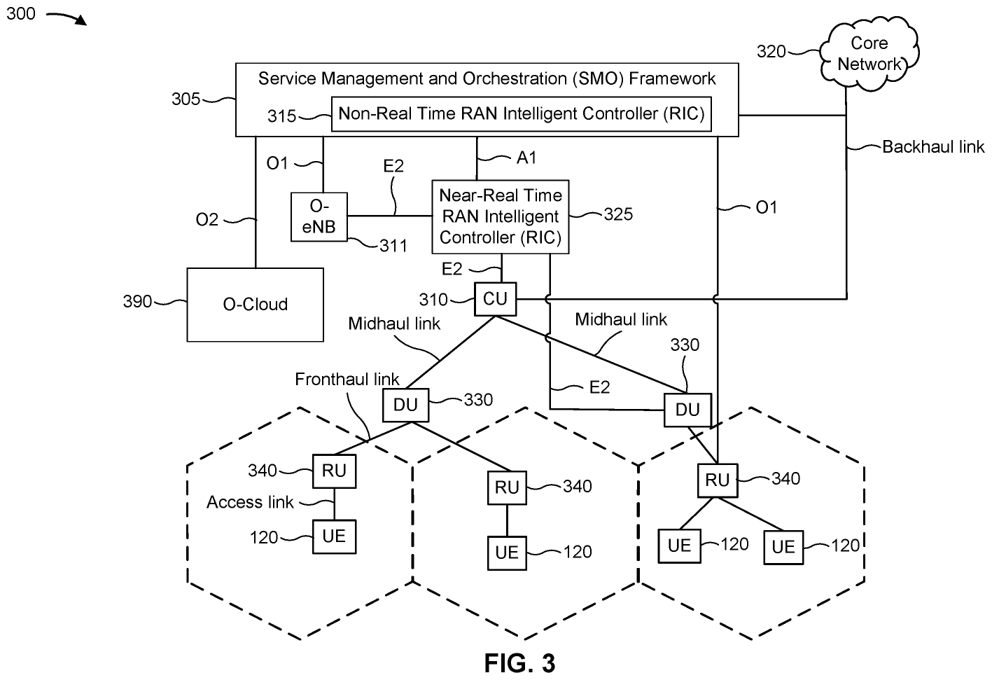

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a two-step RACH procedure, in accordance with the present disclosure. As shown in FIG. 4, a network node 110 and a UE 120 may communicate with one another in a wireless network (e.g., wireless network 100) to perform the two-step RACH procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs) and/or the like) and/or an SSB. Additionally, or alternatively, the random access configuration information may be transmitted in a radio resource control (RRC) message. The random access configuration information may include one or more parameters to be used in the two-step RACH procedure, such as one or more parameters for transmitting a random access message (RAM), receiving a random access response (RAR) to the RAM, and/or the like.

As shown by reference number 410, the UE 120 may transmit, and the network node 110 may receive, a RAM preamble. As shown by reference number 415, the UE 120 may transmit, and the network node 110 may receive, a RAM payload. As shown, the UE 120 may transmit the RAM preamble and the RAM payload to the network node 110 as part of an initial (or first) step of the two-step RACH procedure. In some aspects, the RAM may be referred to as message A, msgA, a first message, an initial message, and/or the like in a two-step RACH procedure. Furthermore, in some aspects, the RAM preamble may be referred to as a message A preamble, a msgA preamble, a preamble, a PRACH preamble, and/or the like, and the RAM payload may be referred to as a message A payload, a msgA payload, a msgA physical uplink shared channel (PUSCH), a payload, and/or the like. In some aspects, the RAM may include some or all of the contents of message 1 (msg1) and message 3 (msg3) of a four-step RACH procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), a PUSCH transmission, and/or the like).

As shown by reference number 420, the network node 110 may receive the RAM preamble transmitted by the UE 120. If the network node 110 successfully receives and decodes the RAM preamble, the network node 110 may then receive and decode the RAM payload.

As shown by reference number 425, the network node 110 may transmit an RAR (sometimes referred to as an RAR message). As shown, the network node 110 may transmit the RAR message as part of a second step of the two-step RACH procedure. In some aspects, the RAR message may be referred to as message B, msgB, or a second message in a two-step RACH procedure. The RAR message may include some or all of the contents of message 2 (msg2) and message 4 (msg4) of a four-step RACH procedure. For example, the RAR message may include the detected PRACH preamble identifier, the detected UE identifier, timing advance information (e.g., a timing advance value, a timing advance command, and/or the like), contention resolution information, and/or the like.

As shown by reference number 430, as part of the second step of the two-step RACH procedure, the network node 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 435, as part of the second step of the two-step RACH procedure, the network node 110 may transmit the PDSCH communication for the RAR, as scheduled by the PDCCH communication. The RAR may be included in a medium access control (MAC) protocol data unit (PDU) of the PDSCH communication. As shown by reference number 440, if the UE 120 successfully receives the RAR, the UE 120 may transmit a hybrid automatic repeat request (HARQ) acknowledgement (ACK).

As indicated above, FIG. 4 is provided as an example. Other examples may differ from what is described with regard to FIG. 4.

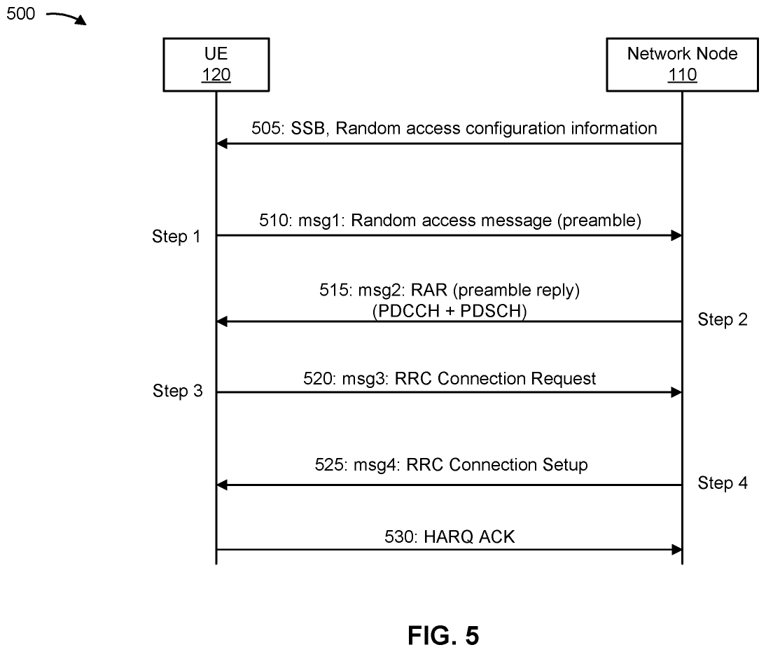

FIG. 5 is a diagram illustrating an example 500 of a four-step RACH procedure, in accordance with the present disclosure. As shown in FIG. 5, a network node 110 and a UE 120 may communicate with one another in a wireless network (e.g., wireless network 100) to perform the four-step RACH procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more SIBs and/or the like) and/or an SSB. Additionally, or alternatively, the random access configuration information may be transmitted in an RRC message. The random access configuration information may include one or more parameters to be used in the RACH procedure, such as one or more parameters for transmitting a RAM, one or more parameters for receiving an RAR, and/or the like.

As shown by reference number 510, the UE 120 may transmit a RAM, which may include a preamble (sometimes referred to as a random access preamble, a PRACH preamble, a RAM preamble, and/or the like). The message that includes the preamble may be referred to as a message 1, msg1, MSG1, a first message, an initial message, and/or the like in a four-step RACH procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step RACH procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step RACH procedure, the network node 110 may transmit a PDCCH communication for the RAR. The PDCCH communication may schedule a PDSCH communication that includes the RAR. For example, the PDCCH communication may indicate a resource allocation for the PDSCH communication. Also, as part of the second step of the four-step RACH procedure, the network node 110 may transmit the PDSCH communication for the RAR, as scheduled by the PDCCH communication. The RAR may be included in a MAC PDU of the PDSCH communication.

As shown by reference number 520, the UE 120 may transmit an RRC connection request message. The RRC connection request message may be referred to as message 3, msg3, MSG3, or a third message of a four-step RACH procedure. In some aspects, the RRC connection request may include a UE identifier, UCI, a PUSCH transmission (e.g., an RRC connection request), and/or the like.

As shown by reference number 525, the network node 110 may transmit an RRC connection setup message. The RRC connection setup message may be referred to as message 4, msg4, MSG4, or a fourth message of a four-step RACH procedure. In some aspects, the RRC connection setup message may include the detected UE identifier, timing advance information (e.g., a timing advance value, a timing advance command, and/or the like), contention resolution information, and/or the like. As shown by reference number 530, if the UE 120 successfully receives the RRC connection setup message, the UE 120 may transmit a HARQ ACK.

As indicated above, FIG. 5 is provided as an example. Other examples may differ from what is described with regard to FIG. 5.

In some aspects, a UE may perform frequency hopping in connection with transmission of a RACH message such as Msg3 or MsgA (e.g., a PUSCH transmission of a RACH procedure). For example, the UE may perform frequency hopping for PUSCH repetition of the PUSCH transmission. For PUSCH repetition Type A scheduled by an RAR uplink grant or by DCI format 0_0 with a cyclic redundancy check (CRC) scrambled by a temporary cell radio network temporary identifier (TC-RNTI) (as allocated, for example, in Msg2), a UE may be configured for frequency hopping by a frequency hopping flag information field of the RAR uplink grant, or by the frequency hopping flag information field of DCI format 0_0 with the CRC scrambled by the TC-RNTI, respectively.

The frequency domain resource allocation may be performed by uplink resource allocation type 1. For an initial uplink BWP size of NB_{BWP}^{size} resource blocks (RBs), a UE may process the frequency domain resource assignment field as follows:
if N_{BWP}^{size}≤180, or for operation with shared spectrum channel access if N_{BWP}^{size}≤90: truncate the frequency domain resource assignment field to its ┌log₂(N_{BWP}^{size}·(N_{BWP}^{size}+1)/2)┐ least significant bits and interpret the truncated frequency resource assignment field as for the frequency resource assignment field in DCI format 0_0 as described in 3GPP Technical Specification (TS) 38.212; or
else: insert ┌log₂(N_{BWP}^{size}·(N_{BWP}^{size}+1)/2)┐−14 most significant bits, or for operation with shared spectrum channel access insert ┌log₂(N_{BWP}^{size}·(N_{BWP}^{size}+1)/2)┐−12 most significant bits, with value set to 0 (zero) after the N_{UL,hop} bits to the frequency domain resource assignment field, where N_{UL,hop}=0 if the frequency hopping flag is set to 0 and N_{UL,hop} is provided in Table 1 if the hopping flag bit is set to 1 (one), and interpret the expanded frequency resource assignment field as for the frequency resource assignment field in DCI format 0_0 as described in 3GPP TS 38.212.

TABLE 1

| Number of PRBs in | | Frequency offset |
|---|---|---|
| initial UL BWP | Value of N_{UL, hop} Hopping Bits | for 2^{nd} hop |
| N_{BWP}^{size} < 50 | 0 | └N_{BWP}^{size}/2┘ |
| | 1 | └N_{BWP}^{size}/4┘ |
| N_{BWP}^{size} ≥ 50 | 00 | └N_{BWP}^{size}/2┘ |
| | 01 | └N_{BWP}^{size}/4┘ |
| | 10 | −└N_{BWP}^{size}/4┘ |
| | 11 | Reserved |

Table 1 depicts frequency offsets for second hops of a PUSCH transmission with frequency hopping scheduled by RAR UL grant or of Msg3 PUSCH retransmission.

For a PUSCH transmission with frequency hopping in a slot, when indicated by msgA-intraSlotFrequencyHopping for the active UL BWP, the frequency offset for the second hop may be determined as described above and using Table 8.3-1 with msgA-HoppingBits instead of N_{UL,hop}. N_{UL,hop} or msgA-HoppingBits may be referred to herein as a frequency hopping codepoint.

In case of intra-slot frequency hopping, the starting RB in each hop may be given by

$${RB}_{start} = \{ \begin{matrix}{RB}_{start} & i = 0 \\ ( {RB}_{start} + {RB}_{offset} ) mod {N}_{BWP}^{size} & i = 1\end{matrix} ,$$

where i=0 and i=1 are the first hop and the second hop respectively, RBₛₜₐᵣₜ, is the starting RB within the UL BWP, as calculated from the resource block assignment information of resource allocation type 1 or as calculated from the resource assignment for MsgA PUSCH, and RB_{offset} is the frequency offset in RBs between the two frequency hops. The number of symbols in the first hop is given by └N_{symb}^{PUCH,s}/2┘, and the number of symbols in the second hop is given by N_{symb}^{PUSCH,s}−└N_{symb}^{PUSCH,s}/2┘, where N_{symb}^{PUSCH,s} is the length of the PUSCH transmission in OFDM symbols in one slot.

In case of inter-slot frequency hopping and when PUSCH-DMRS-Bundling is not enabled, the starting RB during slot nₛ^{μ} is given by

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} ,$$

where nₛ^{μ} is the current slot number within a system radio frame, where a multi-slot PUSCH transmission can take place, RBₛₜₐᵣₜ is the starting RB within the UL BWP, as calculated from the resource block assignment information of resource allocation type 1, and RB_{offset} is the frequency offset in RBs between the two frequency hops.

It can be seen that the above frequency hopping provisions are typically based on a BWP parameter, such as N_{BWP}^{size}. For example, prior to RRC connection establishment, Msg3 and MsgA transmission or retransmission may be configured with a frequency offset for PUSCH transmission. If these frequency offsets are dependent on the size of the UL BWP (as indicated by N_{BWP}^{size}), and if PUSCH transmission is occurring in an SBFD slot or symbol (described below), then limitations on frequency hopping may occur, since some frequency offsets may specify hops that occur outside of an uplink sub-band of the SBFD slot or symbol. Some techniques described herein provide determination of a frequency offset for a hop based at least in part on an uplink sub-band size of an SBFD resource, as described in more detail elsewhere herein.

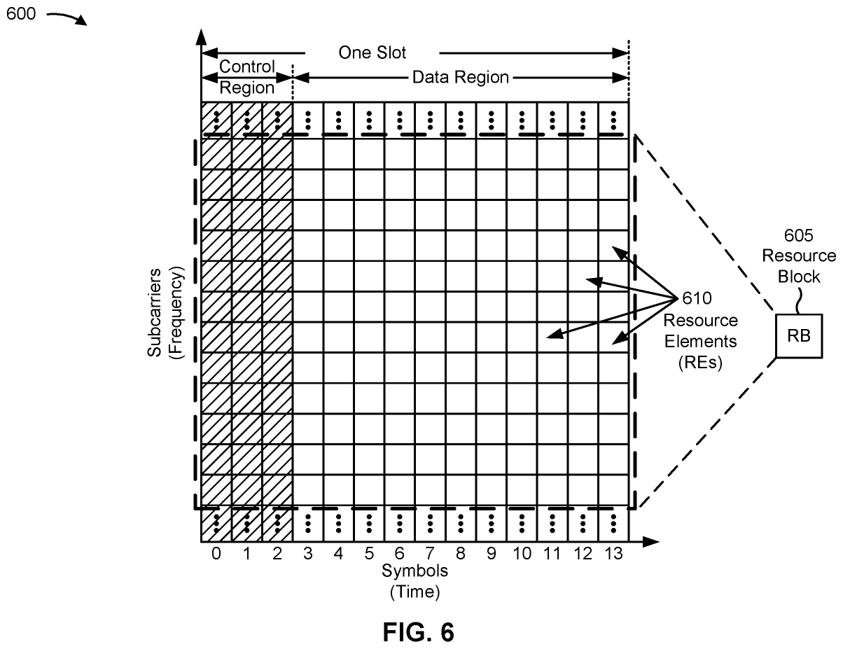

FIG. 6 is a diagram illustrating an example 600 of a slot format, in accordance with the present disclosure. As shown in FIG. 6, time-frequency resources in a radio access network may be partitioned into resource blocks, shown by a single resource block (RB) 605. An RB 605 is sometimes referred to as a physical resource block (PRB). An RB 605 includes a set of subcarriers (e.g., 12 subcarriers) and a set of symbols (e.g., 14 symbols) that are schedulable by a network node 110 as a unit. In some aspects, an RB 605 may include a set of subcarriers in a single slot. As shown, a single time-frequency resource included in an RB 605 may be referred to as a resource element (RE) 610. An RE 610 may include a single subcarrier (e.g., in frequency) and a single symbol (e.g., in time). A symbol may be referred to as an orthogonal frequency division multiplexing (OFDM) symbol. An RE 610 may be used to transmit one modulated symbol, which may be a real value or a complex value. In some aspects, RBs may be bundled together to form resource block groups (RBGs). For example, and as described further herein, an RBG may include multiple RBs, such as 2, 4, 8, or 16 RBs, which are allocated for wireless communication.

In some telecommunication systems (e.g., NR), RBs 605 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 6 is provided as an example. Other examples may differ from what is described with respect to FIG. 6.

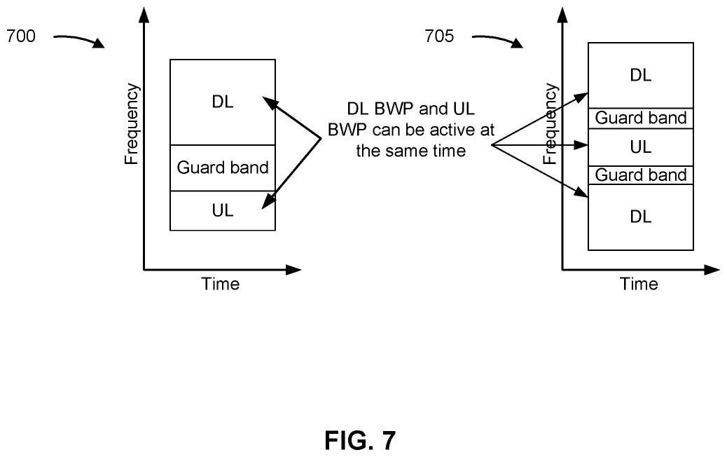

FIG. 7 is a diagram illustrating examples 700 and 705 of sub-band full-duplex (SBFD) communication in a wireless network, in accordance with the present disclosure. “Full-duplex communication” in a wireless network refers to simultaneous bi-directional communication between devices in the wireless network. For example, a UE or network node operating in a full-duplex mode may transmit an uplink communication and receive a downlink communication at the same time (e.g., in the same slot or the same symbol).

SBFD communications may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band (e.g., a bandwidth part), such as a time division duplexing band. In this case, the frequency resources used for downlink communication may be separated from the frequency resources used for uplink communication, in the frequency domain, by one or more guard bands. The configuration of uplink sub-bands and downlink sub-bands, such as a number of uplink sub-bands, a number of downlink sub-bands, a bandwidth of an uplink sub-band, a sub-band size (e.g., bandwidth) of a sub-band, a time resource to which the configuration applies, or a combination thereof, may be indicated by a sub-band configuration, which can be semi-statically signaled to the UE, dynamically indicated to the UE, or signaled to the UE in another fashion.

As indicated above, FIG. 7 is provided as an example. Other examples may differ from what is described with respect to FIG. 7.

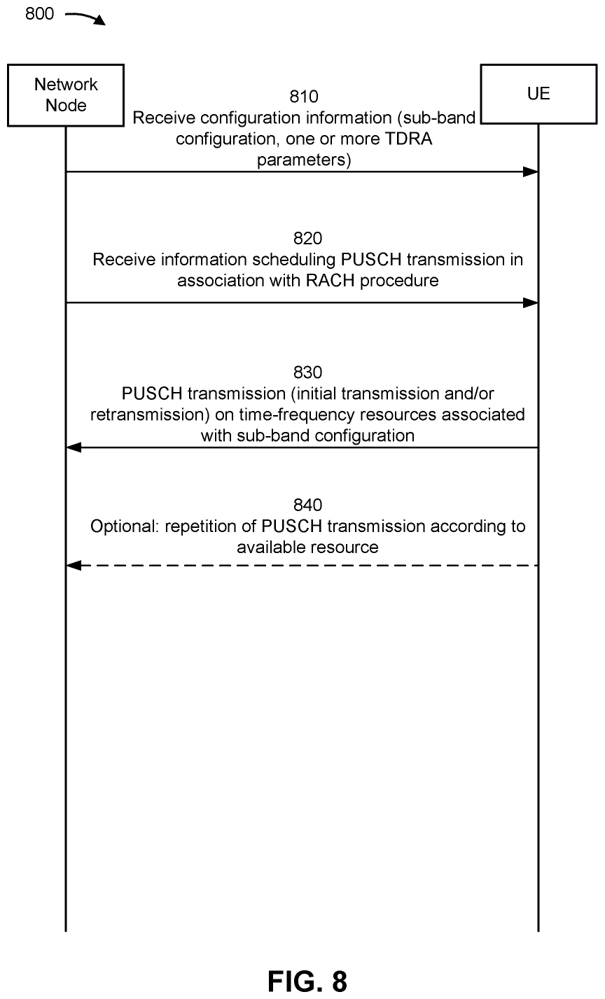

FIG. 8 is a diagram illustrating an example 800 of PUSCH transmission based at least in part on an SBFD slot, in accordance with the present disclosure. As shown, example 800 includes a UE (e.g., UE 120) and a network node (e.g., network node 110).

As shown by reference number 810, the UE may receive configuration information. For example, the UE may receive the configuration information via system information (e.g., a system information block or a master information block), RRC signaling, DCI, a RACH message, or the like. In some aspects, the UE may transmit capability information indicating that the UE is capable of using SBFD or communicating in SBFD resources.

In some aspects, the configuration information may include a sub-band configuration of an SBFD resource (e.g., via broadcast information such as system information), as described above in connection with FIG. 7. For example, the configuration information (e.g., the sub-band configuration) may indicate an uplink sub-band size of the SBFD. The uplink sub-band size is referred to herein as N_{SB}^{size}, and may be in terms of RBs. For example, the uplink sub-band size may indicate a bandwidth of an uplink sub-band of an SBFD resource. In some aspects, the sub-band configuration may indicate a frequency location of an uplink sub-band, such as a lowest RB of the uplink sub-band, a center frequency of the uplink sub-band, or the like. In some aspects, the sub-band configuration may indicate one or more downlink sub-bands of the SBFD resource (e.g., a bandwidth of a downlink sub-band, a frequency location of a downlink sub-band, or the like). In some aspects, the configuration information may include a BWP configuration, which may indicate whether the BWP is an uplink BWP, a bandwidth of the BWP, a frequency location of the uplink BWP, or the like.

In some aspects, the configuration information may include information regarding one or more time-domain resource allocation (TDRA) parameters. For example, the configuration information may include a PUSCH-configCommon information element indicating one or more TDRA parameters. A TDRA parameter may be associated with an index. The index may indicate a row of a TDRA table. The TDRA table may indicate a PUSCH mapping type (which may indicate where a demodulation reference signal is provided in the PUSCH transmission), a K2 parameter (indicating a slot offset that indicates the slot containing the time-domain resource allocation), an S parameter (indicating a starting symbol), an L parameter (indicating a length of the TDRA), or other parameters (e.g., a j parameter used to determine the slot offset K2, a delta parameter indicating an additional slot delay value). The TDRA table may include a limited number of start and length indicator values (SLIVs, which may include S and L). Furthermore, some TDRA tables may include a limited set of starting symbols (e.g., 0, 2, 4, or 8), which may not accommodate a guard period for transition from downlink reception to uplink transmission. Still further, some TDRA tables may not accommodate PUSCH transmission in a slot with mixed SBFD symbols and non-SBFD symbols. Thus, the number of available slots for PUSCH repetition may be limited.

In some aspects, the configuration information (e.g., a PUSCH-configCommon information element) may indicate multiple TDRA parameters corresponding to different slot types. For example, the configuration information may indicate a first TDRA parameter that is for SBFD resources (e.g., an SBFD slot type) and a second TDRA parameter that is for non-SBFD resources (e.g., a non-SBFD slot type). If the PUSCH transmission is associated with (e.g., occurs on) the SBFD resource, the UE may identify time-frequency resources using the first TDRA parameter. If the PUSCH transmission is associated with (e.g., occurs on) the non-SBFD resource, the UE may identify time-frequency resources using the second TDRA parameter.

In some aspects, a TDRA table (e.g., a default PUSCH TDRA A table for a normal CP, or a default PUSCH TDRA A table for an extended CP) may include one or more rows specific to SBFD resources. For example, the one or more rows may include an SLIV that provides different values for start symbol of PUSCH accounting for a guard period for downlink-to-uplink transition. As another example, the one or more rows may include an SLIV that accommodates PUSCH transmission in a slot with mixed SBFD and non-SBFD symbols. Thus, a default TDRA parameter (e.g., a TDRA parameter used to index into a default TDRA table as described above) can be used to identify an SLIV for an SBFD resource.

In some aspects, a TDRA table may be specific to SBFD resources. For example, the UE may use a TDRA parameter indicated by the configuration information to identify a row of an SBFD-specific TDRA table if the PUSCH transmission occurs in an SBFD resource, and may use the TDRA parameter to identify a row of another (e.g., default) TDRA table if the PUSCH transmission does not occur in an SBFD resource.

As shown by reference number 820, the UE may receive information scheduling a PUSCH transmission or retransmission in connection with an initial access or RACH procedure. References herein to a RACH procedure should be understood to also encompass initial access procedures. For example, the information may be received via a RACH message (e.g., a random access resources uplink grant), DCI (e.g., DCI Format 0_0), or the like. The PUSCH transmission may be scheduled at least partially in an SBFD resource. For example, an initial transmission or a retransmission of the PUSCH transmission may occur in or may include the SBFD resource. The PUSCH transmission may include an initial transmission (e.g., scheduled by a random access resources grant) and/or a retransmission (e.g., scheduled by DCI). In some aspects, the information may indicate frequency hopping. For example, the information may indicate to enable frequency hopping and/or may include a frequency hopping codepoint that indicates one or more parameters (e.g., a frequency offset). The frequency hopping can occur within the SBFD resource, or across the SBFD resource and at least one non-SBFD resource.

As shown by reference number 830, the UE may transmit the PUSCH transmission on time and frequency (time-frequency) resources that are associated with a sub-band configuration of the SBFD resource. In some aspects, the time-frequency resources may be associated with the sub-band configuration in that frequency resources (e.g., a frequency offset or a starting RB) for the PUSCH transmission are derived from the sub-band configuration. In some aspects, the time-frequency resources may be associated with the sub-band configuration in that a TDRA parameter used to determine a time-domain resource allocation of the time-frequency resources is for SBFD resources or is specific to SBFD resources. In some aspects, the time-frequency resources may be associated with the sub-band configuration in that a definition of an available resource (used to determine the time-frequency resources) is based at least in part on the sub-band configuration. The PUSCH transmission may include at least one of an initial transmission of a Msg3 or MsgA, a retransmission of the Msg3 or the MsgA, or a repetition of the initial transmission and/or the retransmission.

In some aspects, the UE may transmit the PUSCH transmission using frequency hopping. For example, the PUSCH transmission may include a first hop occurring at a first starting RB and a second hop occurring at a second starting RB different than the first starting RB. The time-frequency resources described herein may include a time and frequency location of the first hop and a time and frequency location of the second hop. The second starting RB may be defined relative to the first starting RB according to a frequency offset. Techniques described herein provide for the frequency offset to be derived from an uplink sub-band size (NsBze), which ensures that the second starting RB occurs within an uplink sub-band of the SBFD resource, unlike if an uplink BWP size is used to determine the frequency offset. For example, Table 2 shows example frequency offsets given N_{SB}^{size}:

TABLE 2

| Number of PRBs in the | Value of | Frequency |
|---|---|---|
| UL subband within the | N_{UL-hops} | offset |
| initial UL BWP | hopping bits | of 2^{nd} hop |
| N_{SB}^{size} < N₁ RBs | 0 | $⌊ \frac{{N}_{SB}^{size}}{2} ⌋$ |
| | 1 | $⌊ \frac{{N}_{SB}^{size}}{4} ⌋$ |
| N_{SB}^{size} ≥ N₁ RBs | 00 | $⌊ \frac{{N}_{SB}^{size}}{2} ⌋$ |
| | 01 | $⌊ \frac{{N}_{SB}^{size}}{4} ⌋$ |
| | 10 | $- ⌊ \frac{{N}_{SB}^{size}}{4} ⌋$ |
| | 11 | $Reserved or - ⌊ \frac{{N}_{SB}^{size}}{2} ⌋$ |

As shown, each value of the frequency offset is proportional to the uplink sub-band size.

In some aspects, the starting RB of the first hop and/or the second hop may be based at least in part on the uplink sub-band size. For example, the starting RB may be referenced to (e.g., may be defined relative to) the lowest RB (in frequency) of an uplink sub-band of the SBFD resource. As another example, the starting RB may be referenced to the lowest RB (in frequency) of an overlapped portion of the uplink sub-band that overlaps with an uplink BWP of the UE. In some aspects, the UE may identify the starting RB of the second hop based at least in part on the starting RB of the first hop (determined as the lowest RB of the uplink sub-band or the lowest RB of the uplink sub-band that overlaps with an uplink BWP of the UE) and the uplink sub-band size. For example, the UE may determine starting RBs for the first hop and the second hop, for intra-slot frequency hopping, as

$${RB}_{start} = \{ \begin{matrix}{RB}_{start} , i = 0 \\ ( {RB}_{start} + {RB}_{offset} ) mod {N}_{SB}^{size} , i = 1\end{matrix} .$$

As another example, the UE may determine starting RBs for the first hop and the second hop, for inter-slot frequency hopping, as

$${RB}_{start} = \{ \begin{matrix}{RB}_{start} , & mod ( {n}_{s}^{μ} , 2 ) = 0 \\ ( {RB}_{start} + {RB}_{offset} ) mod {N}_{SB}^{size} , & mod ( {n}_{s}^{μ} , 2 ) = 1\end{matrix} .$$

As shown by reference number 840, in some aspects, the PUSCH transmission may include a repetition. The repetition may be a repetition of an initial Msg3 (scheduled by Msg2) or may be a repetition of a retransmission of Msg3 (scheduled by DCI format 0_0 with CRC scrambled by TC-RNTI). The PUSCH transmission may be for other initial access messages, e.g. MSG5, that is scheduled by DCI format 0_0. The configuration information (e.g., a system information block 1) may indicate parameters related to Msg3 repetition (which may include a configured set with 4 candidate values for repetition). Two bits of modulation and coding scheme information may be used to select a candidate value for repetition. The number of repetitions may be counted on the basis of available slots for Type A PUSCH repetitions for Msg3. In some examples, an available slot may be based at least in part on an uplink-downlink configuration (e.g., tdd-UL-DL-ConfigurationCommon) indicating uplink resources and downlink resources, and an SSB resource configuration (e.g., ssb-PositionsInBurst) indicating SSB resources (e.g., without considering a sub-band configuration). In such examples, a slot is determined as available for Msg3 repetition only if the consecutive symbols allocated for Msg3 repetition in the slot are all available symbols (i.e., uplink or flexible symbols). If the UE is indicated to transmit a Msg3 PUSCH with repetition, the frequency hopping flag information field in the UL RAR grant or DCI format 0_0 with CRC scrambled by TC-RNTI may be reused to enable/disable inter-slot frequency hopping for the PUSCH repetition. In some techniques described herein, the UE may determine available slots based at least in part on a sub-band configuration. For example, the UE may determine slots for a PUSCH transmission of a PUSCH repetition Type A scheduled by RAR UL grant, based at least in part on tdd-UL-DL-ConfigurationCommon and ssb-PositionsInBurst, a UL and/or DL sub-band configuration, and a TDRA information field value in an RAR UL grant. In such examples, a slot may not be counted as an available slot for a PUSCH transmission of a PUSCH repetition Type A scheduled by RAR UL grant, if at least one of the symbols indicated by the indexed row of the used resource allocation table in the slot overlaps with either a DL symbol indicated by tdd-UL-DL-ConfigurationCommon if provided without a configured UL sub-band, or a symbol of an SSB with index provided by ssb-PositionsInBurst. Thus, time-frequency resources are considered available resources based at least in part on a sub-band configuration of an SBFD resource. For example, the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with techniques for frequency hopping with SBFD.

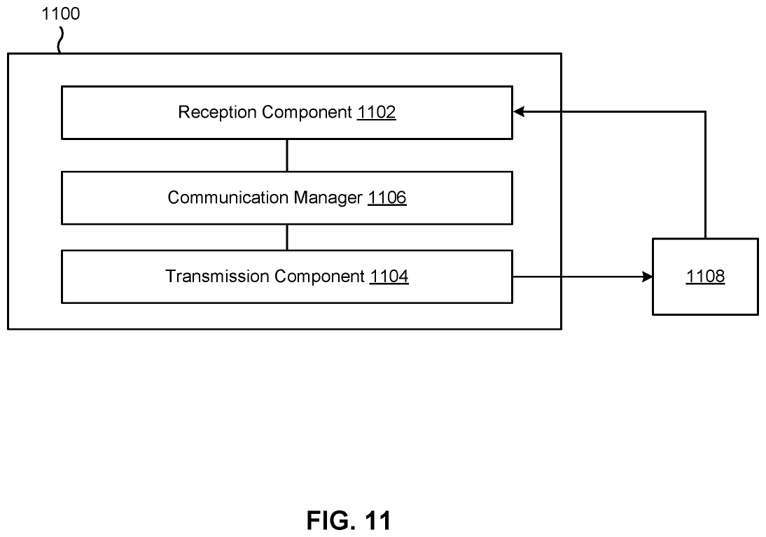

As shown in FIG. 9, in some aspects, process 900 may include receiving information scheduling a PUSCH transmission at least partially in an SBFD resource in connection with a random access channel procedure (block 910). For example, the UE (e.g., using reception component 1102 and/or communication manager 1106, depicted in FIG. 11) may receive information scheduling a PUSCH transmission at least partially in an SBFD resource in connection with a random access channel procedure, as described above.

As further shown in FIG. 9, in some aspects, process 900 may include transmitting the PUSCH transmission on time-frequency resources that are associated with a sub-band configuration of the SBFD resource (block 920). For example, the UE (e.g., using transmission component 1104 and/or communication manager 1106, depicted in FIG. 11) may transmit the PUSCH transmission on time-frequency resources that are associated with a sub-band configuration of the SBFD resource, as described above.

Process 900 may include additional aspects, such as any single aspect or any combination of aspects described below and/or in connection with one or more other processes described elsewhere herein.

In a first aspect, the sub-band configuration indicates one or more uplink sub-bands and one or more downlink sub-bands of the SBFD resource.

In a second aspect, alone or in combination with the first aspect, the sub-band configuration indicates an uplink sub-band size of the SBFD resource, wherein the information scheduling the PUSCH transmission indicates frequency hopping for the PUSCH transmission, and wherein transmitting the PUSCH transmission on time-frequency resources that are associated with the sub-band configuration of the SBFD resource further comprises transmitting the PUSCH transmission using a frequency offset that is derived from the uplink sub-band size and a frequency hopping codepoint indicated by the information scheduling the PUSCH transmission.

In a third aspect, alone or in combination with one or more of the first and second aspects, the frequency offset is determined from a table based at least in part on the frequency hopping codepoint.

In a fourth aspect, alone or in combination with one or more of the first through third aspects, each value of the table is proportional to the uplink sub-band size.

In a fifth aspect, alone or in combination with one or more of the first through fourth aspects, the frequency hopping is intra-slot or inter-slot frequency hopping within only the SBFD resource.

In a sixth aspect, alone or in combination with one or more of the first through fifth aspects, the frequency hopping is intra-slot or inter-slot frequency hopping within the SBFD resource and a non-SBFD resource.

In a seventh aspect, alone or in combination with one or more of the first through sixth aspects, the sub-band configuration indicates an uplink sub-band of the SBFD resource, and transmitting the PUSCH transmission on time-frequency resources that are associated with the sub-band configuration of the SBFD resource further comprises transmitting the PUSCH transmission using a starting resource block that is based at least in part on the uplink sub-band and indicated frequency resources of the PUSCH.

In an eighth aspect, alone or in combination with one or more of the first through seventh aspects, the starting resource block is referenced to a lowest resource block, in frequency, of the uplink sub-band.

In a ninth aspect, alone or in combination with one or more of the first through eighth aspects, the starting resource block is referenced to a lowest resource block, in frequency, of an overlapped portion of the uplink sub-band that overlaps with an uplink bandwidth part of the UE.

In a tenth aspect, alone or in combination with one or more of the first through ninth aspects, the starting resource block is a first starting resource block for a first hop of the PUSCH transmission, and transmitting the PUSCH transmission further comprises transmitting a second hop of the PUSCH transmission, wherein a second starting resource block for the second hop is based at least in part on the starting resource block, a frequency offset, and an uplink sub-band size of the SBFD resource.

In an eleventh aspect, alone or in combination with one or more of the first through tenth aspects, the second starting resource block is based at least in part on a modulo operation on a sum of the starting resource block and the frequency offset, wherein a modulus of the modulo operation is the uplink sub-band size.

In a twelfth aspect, alone or in combination with one or more of the first through eleventh aspects, process 900 includes transmitting the PUSCH transmission in accordance with a start and length indicator value indicated by a particular TDRA parameter, of the plurality of TDRA parameters, based at least in part on the PUSCH transmission occurring on the SBFD resource.

In a thirteenth aspect, alone or in combination with one or more of the first through twelfth aspects, process 900 includes transmitting the PUSCH transmission in accordance with a start and length indicator value indicated by the TDRA parameter, wherein the start and length indicator value is for SBFD resources.

In a fourteenth aspect, alone or in combination with one or more of the first through thirteenth aspects, transmitting the PUSCH transmission on time-frequency resources that are associated with the sub-band configuration of the SBFD resource further comprises transmitting the PUSCH transmission in accordance with a default TDRA parameter that is specific to SBFD resources.

In a fifteenth aspect, alone or in combination with one or more of the first through fourteenth aspects, transmitting the PUSCH transmission on the time-frequency resources further comprises transmitting the PUSCH transmission on the time-frequency resources based at least in part on the time-frequency resources being available resources for the PUSCH transmission, wherein the time-frequency resources are available resources based at least in part on the sub-band configuration of the SBFD resource.

In a sixteenth aspect, alone or in combination with one or more of the first through fifteenth aspects, the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

In a seventeenth aspect, alone or in combination with one or more of the first through sixteenth aspects, the PUSCH transmission comprises at least one of a random access channel message 3 transmission or a random access channel message A transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with techniques for frequency hopping with SBFD.

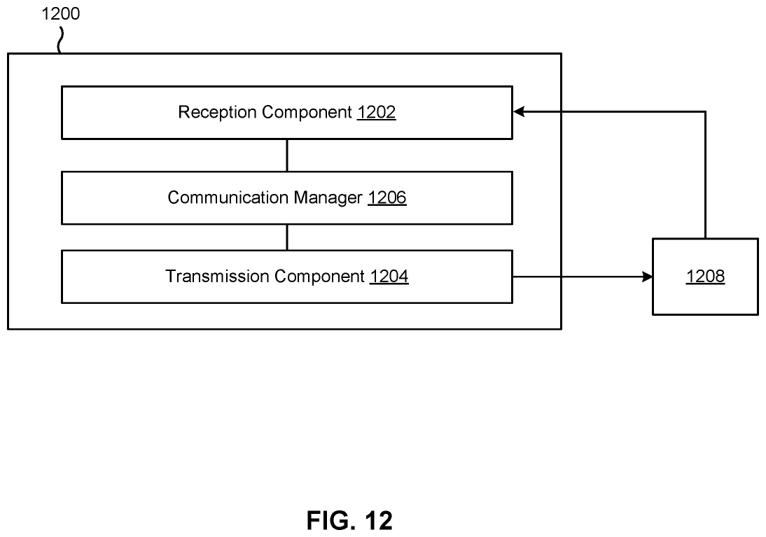

As shown in FIG. 10, in some aspects, process 1000 may include transmitting information scheduling a PUSCH transmission at least partially in an SBFD resource in connection with a random access channel procedure of a UE (block 1010). For example, the network node (e.g., using transmission component 1204 and/or communication manager 1206, depicted in FIG. 12) may transmit information scheduling a PUSCH transmission at least partially in an SBFD resource in connection with a random access channel procedure of a UE, as described above.

As further shown in FIG. 10, in some aspects, process 1000 may include receiving the PUSCH transmission on time-frequency resources that are associated with a sub-band configuration of the SBFD resource (block 1020). For example, the network node (e.g., using reception component 1202 and/or communication manager 1206, depicted in FIG. 12) may receive the PUSCH transmission on time-frequency resources that are associated with a sub-band configuration of the SBFD resource, as described above.

Process 1000 may include additional aspects, such as any single aspect or any combination of aspects described below and/or in connection with one or more other processes described elsewhere herein.

In a first aspect, the sub-band configuration indicates one or more uplink sub-bands and one or more downlink sub-bands of the SBFD resource.

In a second aspect, alone or in combination with the first aspect, the sub-band configuration indicates an uplink sub-band size of the SBFD resource, wherein the information scheduling the PUSCH transmission indicates frequency hopping for the PUSCH transmission, and wherein receiving the PUSCH transmission on time-frequency resources that are associated with the sub-band configuration of the SBFD resource further comprises receiving the PUSCH transmission using a frequency offset that is derived from the uplink sub-band size and a frequency hopping codepoint indicated by the information scheduling the PUSCH transmission.

In a third aspect, alone or in combination with one or more of the first and second aspects, the frequency offset is determined from a table based at least in part on the frequency hopping codepoint.

In a fourth aspect, alone or in combination with one or more of the first through third aspects, each value of the table is proportional to the uplink sub-band size.

In a fifth aspect, alone or in combination with one or more of the first through fourth aspects, the frequency hopping is intra-slot or inter-slot frequency hopping within only the SBFD resource.

In a sixth aspect, alone or in combination with one or more of the first through fifth aspects, the frequency hopping is intra-slot or inter-slot frequency hopping within the SBFD resource and a non-SBFD resource.

In a seventh aspect, alone or in combination with one or more of the first through sixth aspects, the sub-band configuration indicates an uplink sub-band of the SBFD resource, and receiving the PUSCH transmission on time-frequency resources that are associated with the sub-band configuration of the SBFD resource further comprises receiving the PUSCH transmission using a starting resource block that is based at least in part on the uplink sub-band and indicated frequency resources of the PUSCH.

In an eighth aspect, alone or in combination with one or more of the first through seventh aspects, the starting resource block is referenced to a lowest resource block, in frequency, of the uplink sub-band.

In a ninth aspect, alone or in combination with one or more of the first through eighth aspects, the starting resource block is referenced to a lowest resource block, in frequency, of an overlapped portion of the uplink sub-band that overlaps with an uplink bandwidth part of the UE.

In a tenth aspect, alone or in combination with one or more of the first through ninth aspects, the starting resource block is a first starting resource block for a first hop of the PUSCH transmission, and receiving the PUSCH transmission further comprises receiving a second hop of the PUSCH transmission, wherein a second starting resource block for the second hop is based at least in part on the starting resource block, a frequency offset, and an uplink sub-band size of the SBFD resource.

In an eleventh aspect, alone or in combination with one or more of the first through tenth aspects, the second starting resource block is based at least in part on a modulo operation on a sum of the starting resource block and the frequency offset, wherein a modulus of the modulo operation is the uplink sub-band size.

In a twelfth aspect, alone or in combination with one or more of the first through eleventh aspects, process 1000 includes receiving the PUSCH transmission in accordance with a start and length indicator value indicated by a particular TDRA parameter, of the plurality of TDRA parameters, based at least in part on the PUSCH transmission occurring on the SBFD resource.

In a thirteenth aspect, alone or in combination with one or more of the first through twelfth aspects, process 1000 includes receiving the PUSCH transmission in accordance with a start and length indicator value indicated by the TDRA parameter, wherein the start and length indicator value is for SBFD resources.

In a fourteenth aspect, alone or in combination with one or more of the first through thirteenth aspects, receiving the PUSCH transmission on time-frequency resources that are associated with the sub-band configuration of the SBFD resource further comprises receiving the PUSCH transmission in accordance with a default TDRA parameter that is specific to SBFD resources.

In a fifteenth aspect, alone or in combination with one or more of the first through fourteenth aspects, receiving the PUSCH transmission on the time-frequency resources further comprises receiving the PUSCH transmission on the time-frequency resources based at least in part on the time-frequency resources being available resources for the PUSCH transmission, wherein the time-frequency resources are available resources based at least in part on the sub-band configuration of the SBFD resource.

In a sixteenth aspect, alone or in combination with one or more of the first through fifteenth aspects, the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

In a seventeenth aspect, alone or in combination with one or more of the first through sixteenth aspects, the PUSCH transmission comprises at least one of a random access channel message 3 transmission or a random access channel message A transmission.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive information scheduling a PUSCH transmission at least partially in an SBFD resource in connection with a random access channel procedure. The transmission component 1104 may transmit the PUSCH transmission on time-frequency resources that are associated with a sub-band configuration of the SBFD resource.

The transmission component 1104 may transmit the PUSCH transmission in accordance with a start and length indicator value indicated by a particular TDRA parameter, of the plurality of TDRA parameters, based at least in part on the PUSCH transmission occurring on the SBFD resource.

The transmission component 1104 may transmit the PUSCH transmission in accordance with a start and length indicator value indicated by the TDRA parameter, wherein the start and length indicator value is for SBFD resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit information scheduling a PUSCH transmission at least partially in an SBFD resource in connection with a random access channel procedure of a UE. The reception component 1202 may receive the PUSCH transmission on time-frequency resources that are associated with a sub-band configuration of the SBFD resource.

The reception component 1202 may receive the PUSCH transmission in accordance with a start and length indicator value indicated by a particular TDRA parameter, of the plurality of TDRA parameters, based at least in part on the PUSCH transmission occurring on the SBFD resource.

The reception component 1202 may receive the PUSCH transmission in accordance with a start and length indicator value indicated by the TDRA parameter, wherein the start and length indicator value is for SBFD resources.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving information scheduling a physical uplink shared channel (PUSCH) transmission at least partially in a sub-band full duplex (SBFD) resource in connection with a random access channel procedure; and transmitting the PUSCH transmission on time and frequency (time-frequency) resources that are associated with a sub-band configuration of the SBFD resource.

Aspect 2: The method of Aspect 1, wherein the sub-band configuration indicates one or more uplink sub-bands and one or more downlink sub-bands of the SBFD resource.

Aspect 3: The method of any of Aspects 1-2, wherein the sub-band configuration indicates an uplink sub-band size of the SBFD resource, wherein the information scheduling the PUSCH transmission indicates frequency hopping for the PUSCH transmission, and wherein transmitting the PUSCH transmission on time-frequency resources that are associated with the sub-band configuration of the SBFD resource further comprises transmitting the PUSCH transmission using a frequency offset that is derived from the uplink sub-band size and a frequency hopping codepoint indicated by the information scheduling the PUSCH transmission.

Aspect 4: The method of Aspect 3, wherein the frequency offset is determined from a table based at least in part on the frequency hopping codepoint.

Aspect 5: The method of Aspect 4, where each value of the table is proportional to the uplink sub-band size.

Aspect 6: The method of Aspect 3, wherein the frequency hopping is intra-slot or inter-slot frequency hopping within only the SBFD resource.

Aspect 7: The method of Aspect 3, wherein the frequency hopping is intra-slot or inter-slot frequency hopping within the SBFD resource and a non-SBFD resource.

Aspect 8: The method of any of Aspects 1-7, wherein the sub-band configuration indicates an uplink sub-band of the SBFD resource, and wherein transmitting the PUSCH transmission on time-frequency resources that are associated with the sub-band configuration of the SBFD resource further comprises transmitting the PUSCH transmission using a starting resource block that is based at least in part on the uplink sub-band and indicated frequency resources of the PUSCH.

Aspect 9: The method of Aspect 8, wherein the starting resource block is referenced to a lowest resource block, in frequency, of the uplink sub-band.

Aspect 10: The method of Aspect 8, wherein the starting resource block is referenced to a lowest resource block, in frequency, of an overlapped portion of the uplink sub-band that overlaps with an uplink bandwidth part of the UE.

Aspect 11: The method of Aspect 8, wherein the starting resource block is a first starting resource block for a first hop of the PUSCH transmission, and wherein transmitting the PUSCH transmission further comprises transmitting a second hop of the PUSCH transmission, wherein a second starting resource block for the second hop is based at least in part on the starting resource block, a frequency offset, and an uplink sub-band size of the SBFD resource.

Aspect 12: The method of Aspect 11, wherein the second starting resource block is based at least in part on a modulo operation on a sum of the starting resource block and the frequency offset, wherein a modulus of the modulo operation is the uplink sub-band size.

Aspect 13: The method of any of Aspects 1-12, further comprising receiving, prior to the information, configuration information indicating a plurality of time-domain resource allocation (TDRA) parameters, wherein transmitting the PUSCH transmission on time-frequency resources that are associated with the sub-band configuration of the SBFD resource further comprises transmitting the PUSCH transmission in accordance with a start and length indicator value indicated by a particular TDRA parameter, of the plurality of TDRA parameters, based at least in part on the PUSCH transmission occurring on the SBFD resource.

Aspect 14: The method of any of Aspects 1-13, further comprising receiving, prior to the information, configuration information indicating a time-domain resource allocation (TDRA) parameter, wherein transmitting the PUSCH transmission on time-frequency resources that are associated with the sub-band configuration of the SBFD resource further comprises transmitting the PUSCH transmission in accordance with a start and length indicator value indicated by the TDRA parameter, wherein the start and length indicator value is for SBFD resources.

Aspect 15: The method of any of Aspects 1-14, wherein transmitting the PUSCH transmission on time-frequency resources that are associated with the sub-band configuration of the SBFD resource further comprises transmitting the PUSCH transmission in accordance with a default time-domain resource allocation (TDRA) parameter that is specific to SBFD resources.

Aspect 16: The method of any of Aspects 1-15, wherein transmitting the PUSCH transmission on the time-frequency resources further comprises transmitting the PUSCH transmission on the time-frequency resources based at least in part on the time-frequency resources being available resources for the PUSCH transmission, wherein the time-frequency resources are available resources based at least in part on the sub-band configuration of the SBFD resource.

Aspect 17: The method of Aspect 16, wherein the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

Aspect 18: The method of any of Aspects 1-17, wherein the PUSCH transmission comprises at least one of a random access channel message 3 transmission or a random access channel message A transmission.

Aspect 19: A method of wireless communication performed by a network node, comprising: transmitting information scheduling a physical uplink shared channel (PUSCH) transmission at least partially in a sub-band full duplex (SBFD) resource in connection with a random access channel procedure of a user equipment (UE); and receiving the PUSCH transmission on time and frequency (time-frequency) resources that are associated with a sub-band configuration of the SBFD resource.

Aspect 20: The method of Aspect 19, wherein the sub-band configuration indicates one or more uplink sub-bands and one or more downlink sub-bands of the SBFD resource.

Aspect 21: The method of any of Aspects 19-20, wherein the sub-band configuration indicates an uplink sub-band size of the SBFD resource, wherein the information scheduling the PUSCH transmission indicates frequency hopping for the PUSCH transmission, and wherein receiving the PUSCH transmission on time-frequency resources that are associated with the sub-band configuration of the SBFD resource further comprises receiving the PUSCH transmission using a frequency offset that is derived from the uplink sub-band size and a frequency hopping codepoint indicated by the information scheduling the PUSCH transmission.

Aspect 22: The method of Aspect 21, wherein the frequency offset is determined from a table based at least in part on the frequency hopping codepoint.

Aspect 23: The method of Aspect 22, where each value of the table is proportional to the uplink sub-band size.

Aspect 24: The method of Aspect 21, wherein the frequency hopping is intra-slot or inter-slot frequency hopping within only the SBFD resource.

Aspect 25: The method of Aspect 21, wherein the frequency hopping is intra-slot or inter-slot frequency hopping within the SBFD resource and a non-SBFD resource.

Aspect 26: The method of any of Aspects 19-25, wherein the sub-band configuration indicates an uplink sub-band of the SBFD resource, and wherein receiving the PUSCH transmission on time-frequency resources that are associated with the sub-band configuration of the SBFD resource further comprises receiving the PUSCH transmission using a starting resource block that is based at least in part on the uplink sub-band and indicated frequency resources of the PUSCH.

Aspect 27: The method of Aspect 26, wherein the starting resource block is referenced to a lowest resource block, in frequency, of the uplink sub-band.

Aspect 28: The method of Aspect 26, wherein the starting resource block is referenced to a lowest resource block, in frequency, of an overlapped portion of the uplink sub-band that overlaps with an uplink bandwidth part of the UE.

Aspect 29: The method of Aspect 26, wherein the starting resource block is a first starting resource block for a first hop of the PUSCH transmission, and wherein receiving the PUSCH transmission further comprises receiving a second hop of the PUSCH transmission, wherein a second starting resource block for the second hop is based at least in part on the starting resource block, a frequency offset, and an uplink sub-band size of the SBFD resource.

Aspect 30: The method of Aspect 29, wherein the second starting resource block is based at least in part on a modulo operation on a sum of the starting resource block and the frequency offset, wherein a modulus of the modulo operation is the uplink sub-band size.

Aspect 31: The method of any of Aspects 19-30, further comprising transmitting, prior to the information, configuration information indicating a plurality of time-domain resource allocation (TDRA) parameters, wherein receiving the PUSCH transmission on time-frequency resources that are associated with the sub-band configuration of the SBFD resource further comprises receiving the PUSCH transmission in accordance with a start and length indicator value indicated by a particular TDRA parameter, of the plurality of TDRA parameters, based at least in part on the PUSCH transmission occurring on the SBFD resource.

Aspect 32: The method of any of Aspects 19-31, further comprising transmitting, prior to the information, configuration information indicating a time-domain resource allocation (TDRA) parameter, wherein receiving the PUSCH transmission on time-frequency resources that are associated with the sub-band configuration of the SBFD resource further comprises receiving the PUSCH transmission in accordance with a start and length indicator value indicated by the TDRA parameter, wherein the start and length indicator value is for SBFD resources.

Aspect 33: The method of any of Aspects 19-32, wherein receiving the PUSCH transmission on time-frequency resources that are associated with the sub-band configuration of the SBFD resource further comprises receiving the PUSCH transmission in accordance with a default time-domain resource allocation (TDRA) parameter that is specific to SBFD resources.

Aspect 34: The method of any of Aspects 19-33, wherein receiving the PUSCH transmission on the time-frequency resources further comprises receiving the PUSCH transmission on the time-frequency resources based at least in part on the time-frequency resources being available resources for the PUSCH transmission, wherein the time-frequency resources are available resources based at least in part on the sub-band configuration of the SBFD resource.

Aspect 35: The method of Aspect 34, wherein the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

Aspect 36: The method of any of Aspects 19-35, wherein the PUSCH transmission comprises at least one of a random access channel message 3 transmission or a random access channel message A transmission.

Aspect 37: An apparatus for wireless communication at a device, comprising a processor; memory coupled with the processor; and instructions stored in the memory and executable by the processor to cause the apparatus to perform the method of one or more of Aspects 1-36.

Aspect 38: A device for wireless communication, comprising a memory and one or more processors coupled to the memory, the one or more processors configured to perform the method of one or more of Aspects 1-36.

Aspect 39: An apparatus for wireless communication, comprising at least one means for performing the method of one or more of Aspects 1-36.

Aspect 40: A non-transitory computer-readable medium storing code for wireless communication, the code comprising instructions executable by a processor to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
a memory; and
one or more processors, coupled to the memory, configured to:
receive information scheduling a physical uplink shared channel (PUSCH) transmission at least partially in a sub-band full duplex (SBFD) resource in connection with a random access channel procedure; and
transmit the PUSCH transmission on time and frequency (time-frequency) resources that are associated with a sub-band configuration of the SBFD resource.

2. The UE of claim 1, wherein the sub-band configuration indicates one or more uplink sub-bands and one or more downlink sub-bands of the SBFD resource.

3. The UE of claim 1, wherein the sub-band configuration indicates an uplink sub-band size of the SBFD resource, wherein the information scheduling the PUSCH transmission indicates frequency hopping for the PUSCH transmission, and
wherein the one or more processors, to transmit the PUSCH transmission on time-frequency resources that are associated with the sub-band configuration of the SBFD resource, are configured to transmit the PUSCH transmission using a frequency offset that is derived from the uplink sub-band size and a frequency hopping codepoint indicated by the information scheduling the PUSCH transmission.

4. The UE of claim 3, wherein the frequency offset is determined from a table based at least in part on the frequency hopping codepoint.

5. The UE of claim 4, where each value of the table is proportional to the uplink sub-band size.

6. The UE of claim 3, wherein the frequency hopping is intra-slot or inter-slot frequency hopping within only the SBFD resource.

7. The UE of claim 3, wherein the frequency hopping is intra-slot or inter-slot frequency hopping within the SBFD resource and a non-SBFD resource.

8. The UE of claim 1, wherein the sub-band configuration indicates an uplink sub-band of the SBFD resource, and
wherein the one or more processors, to transmit the PUSCH transmission on time-frequency resources that are associated with the sub-band configuration of the SBFD resource, are configured to transmit the PUSCH transmission using a starting resource block that is based at least in part on the uplink sub-band and indicated frequency resources of the PUSCH.

9. The UE of claim 8, wherein the starting resource block is referenced to a lowest resource block, in frequency, of the uplink sub-band.

10. The UE of claim 8, wherein the starting resource block is referenced to a lowest resource block, in frequency, of an overlapped portion of the uplink sub-band that overlaps with an uplink bandwidth part of the UE.

11. The UE of claim 8, wherein the starting resource block is a first starting resource block for a first hop of the PUSCH transmission, and wherein the one or more processors, to transmit the PUSCH transmission on the time-frequency resources, are configured to transmit a second hop of the PUSCH transmission, wherein a second starting resource block for the second hop is based at least in part on the starting resource block, a frequency offset, and an uplink sub-band size of the SBFD resource.

12. The UE of claim 11, wherein the second starting resource block is based at least in part on a modulo operation on a sum of the starting resource block and the frequency offset, wherein a modulus of the modulo operation is the uplink sub-band size.

13. The UE of claim 1, wherein the one or more processors are further configured to receiving, prior to the information, configuration information indicating a plurality of time-domain resource allocation (TDRA) parameters, wherein the one or more processors, to transmit the PUSCH transmission on the time-frequency resources, are configured to transmit the PUSCH transmission in accordance with a start and length indicator value indicated by a particular TDRA parameter, of the plurality of TDRA parameters, based at least in part on the PUSCH transmission occurring on the SBFD resource.

14. The UE of claim 1, wherein the one or more processors are further configured to receive, prior to the information, configuration information indicating a time-domain resource allocation (TDRA) parameter, wherein the one or more processors, to transmit the PUSCH transmission on the time-frequency resources, are configured to transmit the PUSCH transmission in accordance with a start and length indicator value indicated by the TDRA parameter, wherein the start and length indicator value is for SBFD resources.

15. The UE of claim 1, wherein the one or more processors, to transmit the PUSCH transmission on time-frequency resources that are associated with the sub-band configuration of the SBFD resource, are configured to transmit the PUSCH transmission in accordance with a default time-domain resource allocation (TDRA) parameter that is specific to SBFD resources.

16. The UE of claim 1, wherein the one or more processors, to transmit the PUSCH transmission on the time-frequency resources, are configured to transmit the PUSCH transmission on the time-frequency resources based at least in part on the time-frequency resources being available resources for the PUSCH transmission, wherein the time-frequency resources are available resources based at least in part on the sub-band configuration of the SBFD resource.

17. The UE of claim 16, wherein the time-frequency resources are available resources based at least in part on the time-frequency resources not overlapping with a downlink symbol that does not include a configured uplink sub-band according to the sub-band configuration, and based at least in part on the time-frequency resources not including a synchronization signal block resource.

18. The UE of claim 1, wherein the PUSCH transmission comprises at least one of a random access channel message 3 transmission or a random access channel message A transmission.

19. A network node for wireless communication, comprising:
a memory; and
one or more processors, coupled to the memory, configured to:
transmit information scheduling a physical uplink shared channel (PUSCH) transmission at least partially in a sub-band full duplex (SBFD) resource in connection with a random access channel procedure of a user equipment (UE); and
receive the PUSCH transmission on time and frequency (time-frequency) resources that are associated with a sub-band configuration of the SBFD resource.

20. The network node of claim 19, wherein the sub-band configuration indicates an uplink sub-band size of the SBFD resource, wherein the information scheduling the PUSCH transmission indicates frequency hopping for the PUSCH transmission, and
wherein the one or more processors, to receive the PUSCH transmission on time-frequency resources that are associated with the sub-band configuration of the SBFD resource, are configured to receive the PUSCH transmission using a frequency offset that is derived from the uplink sub-band size and a frequency hopping codepoint indicated by the information scheduling the PUSCH transmission.

21. The network node of claim 19, wherein the sub-band configuration indicates an uplink sub-band of the SBFD resource, and
wherein the one or more processors, to receive the PUSCH transmission on time-frequency resources that are associated with the sub-band configuration of the SBFD resource, are configured to receive the PUSCH transmission using a starting resource block that is based at least in part on the uplink sub-band and indicated frequency resources of the PUSCH.

22. The network node of claim 21, wherein the starting resource block is a first starting resource block for a first hop of the PUSCH transmission, and wherein the one or more processors, to receive the PUSCH transmission, are configured to receive a second hop of the PUSCH transmission, wherein a second starting resource block for the second hop is based at least in part on the starting resource block, a frequency offset, and an uplink sub-band size of the SBFD resource.

23. The network node of claim 19, wherein the one or more processors are further configured to transmit, prior to the information, configuration information indicating a plurality of time-domain resource allocation (TDRA) parameters, wherein the one or more processors, to receive the PUSCH transmission on time-frequency resources that are associated with the sub-band configuration of the SBFD resource, are further configured to receive the PUSCH transmission in accordance with a start and length indicator value indicated by a particular TDRA parameter, of the plurality of TDRA parameters, based at least in part on the PUSCH transmission occurring on the SBFD resource.

24. The network node of claim 19, wherein the one or more processors are further configured to transmit, prior to the information, configuration information indicating a time-domain resource allocation (TDRA) parameter, wherein the one or more processors, to receive the PUSCH transmission on time-frequency resources that are associated with the sub-band configuration of the SBFD resource, are further configured to receive the PUSCH transmission in accordance with a start and length indicator value indicated by the TDRA parameter, wherein the start and length indicator value is for SBFD resources.

25. The network node of claim 19, wherein the one or more processors, to receive the PUSCH transmission on time-frequency resources that are associated with the sub-band configuration of the SBFD resource, are configured to receive the PUSCH transmission in accordance with a default time-domain resource allocation (TDRA) parameter that is specific to SBFD resources.

26. The network node of claim 19, wherein the one or more processors, to receive the PUSCH transmission on the time-frequency resources, are configured to receive the PUSCH transmission on the time-frequency resources based at least in part on the time-frequency resources being available resources for the PUSCH transmission, wherein the time-frequency resources are available resources based at least in part on the sub-band configuration of the SBFD resource.

27. A method of wireless communication performed by a user equipment (UE), comprising:
receiving information scheduling a physical uplink shared channel (PUSCH) transmission at least partially in a sub-band full duplex (SBFD) resource in connection with a random access channel procedure; and
transmitting the PUSCH transmission on time and frequency (time-frequency) resources that are associated with a sub-band configuration of the SBFD resource.

28. The method of claim 27, wherein the sub-band configuration indicates an uplink sub-band size of the SBFD resource, wherein the information scheduling the PUSCH transmission indicates frequency hopping for the PUSCH transmission, and
wherein transmitting the PUSCH transmission on time-frequency resources that are associated with the sub-band configuration of the SBFD resource further comprises transmitting the PUSCH transmission using a frequency offset that is derived from the uplink sub-band size and a frequency hopping codepoint indicated by the information scheduling the PUSCH transmission.

29. A method of wireless communication performed by a network node, comprising:
transmitting information scheduling a physical uplink shared channel (PUSCH) transmission at least partially in a sub-band full duplex (SBFD) resource in connection with a random access channel procedure of a user equipment (UE); and
receiving the PUSCH transmission on time and frequency (time-frequency) resources that are associated with a sub-band configuration of the SBFD resource.

30. The method of claim 29, wherein the sub-band configuration indicates an uplink sub-band size of the SBFD resource, wherein the information scheduling the PUSCH transmission indicates frequency hopping for the PUSCH transmission, and
wherein receiving the PUSCH transmission on time-frequency resources that are associated with the sub-band configuration of the SBFD resource further comprises receiving the PUSCH transmission using a frequency offset that is derived from the uplink sub-band size and a frequency hopping codepoint indicated by the information scheduling the PUSCH transmission.
